(19) United States
(12) Patent Application Publication
(10) Pub. No.: US 2026/0311382 A1
(43) Pub. Date: Oct. 8, 2026

(54) High Likeness High Compliance Human Figure Generation

(71) Applicant: Sublimate AI, Inc., Austin, TX (US)

(72) Inventor: Sarah Laszlo, Austin, TX (US)

(73) Assignee: Sublimate AI, Inc., Austin, TX (US)

(21) Appl. No.: 19/633,399

(22) Filed: Mar. 30, 2026

Related U.S. Application Data
(60) Provisional application No. 63/870,369, filed on Aug. 26, 2025.
(60) Provisional application No. 63/837,573, filed on Jul. 2, 2025.
(60) Provisional application No. 63/783,313, filed on Apr. 4, 2025.

(51) Int. Cl. G06T 11/00; G06N 3/092

(52) U.S. Cl. CPC G06T 11/00; G06N 3/092

(57) ABSTRACT

Techniques relating to high likeness high compliance human figure generation are disclosed. A method for high likeness high compliance human figure generation may include selecting training images as a basis for an expert learning model, obtaining embeddings for the training images, the embedding being recorded separately for each expert, computing a geometric property of the embedding space for each expert, embedding a received prompt using the same embedding method as for the training images, and generating an output image using a subset of experts selected for highest compliance (e.g., most similarity) to the received prompt, or for other purposes. A system for implementing this method may include a training data ensemble, an image augmentation pipeline, an LLM and other neural networks, a mood and style ensemble of lightweight expert models built on a foundational model, and a tokenizer.

### CROSS-REFERENCE TO RELATED APPLICATIONS

This application claims the benefit of U.S. Provisional Patent Application No. 63/783/313 entitled “A Method for High Likeness, High Compliance Human Figure Generation,” filed Apr. 4, 2025, U.S. Provisional Patent Application No. 63/837,573 entitled “A method for scalable couture in high likeness AI-generated human figures,” filed Jul. 2, 2025, and U.S. Provisional Patent Application No. 63/870,369 entitled “Native Super Resolution and Data Augmentation for AI-generated Images,” filed Feb. 6, 2026, all of which are hereby incorporated by reference in their entirety.

### BACKGROUND OF INVENTION

In artificial intelligence (AI) systems designed for human figure generation, likeness to a target subject is typically anti-correlated with prompt compliance. In conventional systems and methods for human figure generation, modal likeness score for low compliance generations is higher than the modal likeness score for high compliance generations. Generally, when generating a target human figure, likeness suffers when prompt compliance is high.

One way of addressing the problem is by applying a mixture of experts (MoE) approach to the AI generation system, wherein multiple expert networks (i.e., learners) are used, each expert network trained on a homogeneous region of a problem space. Using an MoE to generate a target figure can improve both likeness and compliance, as separate experts equally good at generating a particular likeness can be trained for different portions of the possible generation space. Compliance of generations created using an expert subset of the space will be higher than compliance of generations created from the entire generation space. There exists limited literature of prior approaches using MoE for image generation (e.g., Segmind Mixture of Diffusion Experts (SegMoE) and Mixture of Experts of Generative Adversarial Networks for Multimodal Image Generation (MEGAN)). However, the use of MoE introduced another problem of deciding which expert models to use in response to each generation prompt. Without reliable and efficient methods to route prompts to a subset of relevant experts, rather than the full set of experts as in the prior art, the increase in time and expense to attain high compliance for a given level of likeness can be prohibitive.

In addition to the challenges of attaining high compliance and high likeness in figure generation is generating high likeness to a human subject that is also wearing realistic, well-fitting clothing. Existing techniques exist for generating generic models wearing high quality clothing, but these techniques cannot produce high likeness to particular humans (e.g., celebrities, athletes, models, and other real life persons).

Therefore, improved techniques for high likeness high compliance human figure generation are desirable.

### BRIEF SUMMARY

A system and method are disclosed for high likeness high compliance human figure generation. A method for generating a high likeness high compliance human figure may include: selecting a set of training images as a basis for each expert of a plurality of experts; performing data augmentation on the set of training images; obtaining an embedding for each image of the set of training images, the embedding being recorded separately for each expert of the plurality of experts, each expert having a separate embedding space; computing a geometric property of the separate embedding space for each expert; receiving a prompt for inference; obtaining another embedding for the prompt; computing a similarity between the another embedding and the embedding space for each expert using the geometric property; and generating an output image based on the prompt using an inference by a subset of experts selected according to the computed similarity, the output image comprising a high likeness high compliance human figure. In some examples, each expert of the plurality of experts is trained in one mood, style, or other characteristic. In some examples, each expert comprises a low-rank adaptation (LoRA) of a foundation model.

In some examples, data augmentation comprises one, or a combination, of desaturation, application of noise, rotation, and translation. In some examples, obtaining the embedding and obtaining the another embedding comprises use of a same embedding technique. In some examples, the embedding comprises a multimodal representation of an image and the another embedding comprises a multimodal representation of a prompt. In some examples, the embedding and the another embedding are obtained using one, or a combination, of an LLM, a prompt CLIP, and an image CLIP. In some examples, the embedding and the another embedding are obtained by a weighted combination of two or more of the LLM, the prompt CLIP, and the image CLIP. In some examples, the geometric property comprises one or both of a centroid and a surface. In some examples, computing the similarity between the another embedding and the embedding space for each expert comprises calculating a distance between the another embedding and the centroid of the embedding space for each expert. In some examples, computing the similarity between the another embedding and the embedding space for each expert comprises calculating a distance from the another embedding to a closest point on the surface of the embedding space for each expert.

In some examples, the method also includes selecting the subset of experts to include a given number of experts that are most similar to the prompt. In some examples, the method also includes selecting the subset of experts to include an expert outside of a similarity threshold to the prompt. In some examples, the method also includes returning complex reinforcement learning with human feedback (RLHF) for selecting the subset of experts for a same or similar future prompt.

A system for generating a high likeness high compliance human figure may include: a memory comprising non-transitory computer-readable storage medium configured to store image data, a plurality of embeddings, and a plurality of experts; one or more processors configured to execute instructions stored on the non-transitory computer-readable storage medium to implement: a training data ensemble configured to store a plurality of images; an image augmentation pipeline configured to perform data augmentation on the plurality of images; a neural network configured to generate an embedding for each of the plurality of images; a mood and style ensemble comprising a plurality of experts, each expert comprising a lightweight model being built on a foundational model; a separate embedding space for each expert in the plurality of experts; and a tokenizer configured to generate a prompt embedding. In some examples, the neural network comprises a large language model (LLM). In some examples, the neural network is configured to generate a multimodal representation of an image. In some examples, the neural network comprises a Contrastive Language-Image Pre-training (CLIP) model. In some examples, the one or more processors is configured to also implement a complex reinforcement learning with human feedback loop. In some examples, each expert comprises a low-rank adaptation (LoRA) of the foundation model.

### BRIEF DESCRIPTION OF THE DRAWINGS

Various non-limiting and non-exhaustive aspects and features of the present disclosure are described hereinbelow with references to the drawings, wherein:

FIG. 1A is a simplified block diagram illustrating an exemplary system for high likeness high compliance human figure generation, in accordance with one or more embodiments.

FIG. 1B is a simplified block diagram illustrating an alternative exemplary system for high likeness high compliance human figure generation, in accordance with one or more embodiments.

FIG. 2 is a simplified block diagram illustrating an exemplary system for scalable fashion in high likeness AI-generated human figures, in accordance with one or more embodiments.

FIG. 3A is a line drawing representing an exemplary reference image providing a clothing reference for scalable fashion in high likeness human figure generation, in accordance with one or more embodiments.

FIG. 3B is a series of line drawings illustrating an exemplary AI-generated human figure being clothed by a method for scalable fashion in high likeness AI-generated human figures, in accordance with one or more embodiments.

FIG. 4 is a simplified line drawing illustrating an exemplary user interface for tuning an expert to a desired training checkpoint, in accordance with one or more embodiments.

FIG. 5 is a flow diagram illustrating a method for generating a high likeness high compliance human figure, in accordance with one or more embodiments.

FIG. 6 is a flow diagram illustrating an alternative method for generating a high likeness high compliance human figure, in accordance with one or more embodiments.

FIG. 7 is a flow diagram illustrating a method for scalable fashion in high likeness AI-generated human figures, in accordance with one or more embodiments.

FIG. 8A is a simplified block diagram of an exemplary computing system configured to implement the systems shown in FIGS. 1A-1B and 2, interfaces shown in FIG. 4, and to perform steps of the method illustrated in FIGS. 5-7, in accordance with one or more embodiments.

FIG. 8B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to high likeness high compliance human figure generation using artificial intelligence. The techniques described herein use a mixture of experts (MoE) approach, wherein each expert comprises a lightweight neural network (e.g., learning model) trained on a homogeneous region of a problem space. When generating a human figure using a MoE approach, it is desirable to route generations only to a limited subset of relevant experts for inference, in order to keep inference time and expense constant even as number of experts in the system increases. This constraint ensures that inference time and expense can remain constant even while compliance becomes arbitrarily (i.e., reliably) good for a given level of likeness. The present invention provides a novel means of performing expert routing – routing a prompt to be inferenced by only the experts best suited to generate a desired outcome of the prompt (e.g., often a human figure most similar to (i.e., most compliant to) the prompt is desired, but also may be a human figure somewhat similar to the prompt, a human figure that varies from the prompt in a certain manner, a surprise human figure very different (i.e., low compliance) from the prompt, other desired outcomes, and combinations thereof). In some examples, the number of experts may be grown to a very large number (i.e., an unlimited size), thereby improving compliance to a very high (i.e., unlimited) factor, without sacrificing likeness and without increasing inference time. Constant scaling of inference cost in the MoE is achieved by inferencing only a subset of experts (i.e., expert learning models) that are most related to (i.e., most similar to) the input prompt, or are otherwise configured to be included in the subset for other purposes described herein.

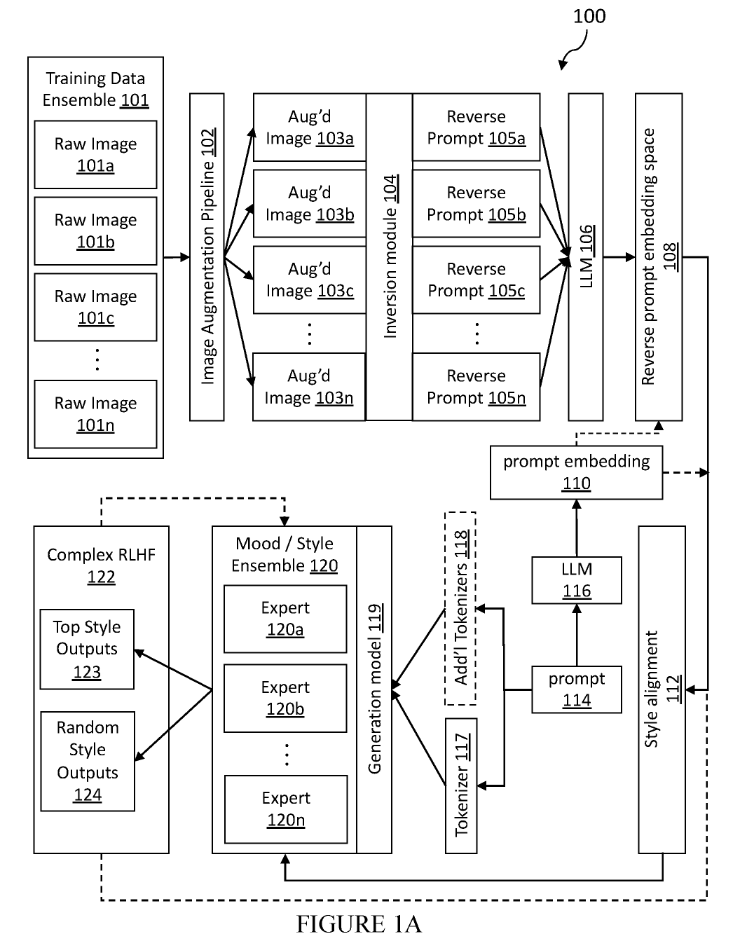

FIG. 1A is a simplified block diagram illustrating an exemplary system for high likeness high compliance human figure generation, in accordance with one or more embodiments. In diagram 100, the system may comprise training data ensemble 101, image augmentation pipeline 102, inversion module 104, large language model (LLM) 106, reverse prompt embedding space 108, prompt embedding 110, style alignment module 112, LLM 116, tokenizers 117-118, generation model 119, mood / style ensemble 120, and complex reinforcement learning with human feedback (RLHF) module 122.

A training data ensemble 101 comprising raw images 101a, 101b, 101c, through to 101n, may be provided (i.e., fed, directed) to an image augmentation pipeline 102. In some examples, training images (i.e., raw images 101a-101n) may be selected (e.g., manually, automatically, etc.) as a basis for an expert (e.g., one of experts 120a-120n in mood / style ensemble 120). There is no limit to the number of raw images 101a-101n in training data ensemble 151 (e.g., could be order(O) of thousands, millions, billions, essentially infinite). Mood / style ensemble 120 comprises the MoE of experts 120a-120n, and each of experts 120a-120n may correspond to a mood, style, or other characteristic of a human figure. For example, expert 120a may correspond to “blonde hair,” expert 120b may correspond to “smiling,” expert 120c may correspond to “face profile,” profile 120n may correspond to “brown eyes,” while other experts may correspond to attributes such as “cute,” “like a painting,” “impressionist style,” “cubist style,” “photography style,” “journalistic style,” “anime style,” etc. There may be an unlimited number of other experts (e.g., clothing type, clothing style, clothing color, clothing pattern, face / facial feature shape, face / facial feature color, facial expression, mood, proportions, sizes, backgrounds, scenery, other visual attributes, other stylistic attributes, other emotional attributes, etc.). There is no limit to the number of experts 120a-120n (e.g., (O)thousands, (O)millions, (O)billions, essentially infinite) that may be trained. Image augmentation pipeline 102 may be configured to generate augmented image data 103a, 103b, 103c, through to 103n, wherein augmented image data 103a results from raw image 101a, augmented image data 103b results from raw image 101b, augmented image data 103c results from raw image 101c, and so on. Data augmentation of any desired type may be performed by image augmentation pipeline 102 (e.g., desaturation, application of noise, rotation, translation, etc.). Inversion module 104 may be configured to convert augmented image data 103a-103n into reverse (i.e., inverted) prompt 105a-105n (e.g., using contrastive language-image pre-training (CLIP) inversion, another multimodal pre-training inversion, and other inversion techniques for converting image data to text for embedding). For example, inversion module 104 may convert augmented image data 103a into reverse prompt 105a, augmented image data 103b into reverse prompt 105b, augmented image data 103c into reverse prompt 105c, and so on through to reverse prompt 105n.

A multidimensional embedding (i.e., embedding representing text description of an image in multiple ways) may be computed for each inverted prompt 105a-105n by LLM 106 and stored (e.g., organized) in reverse prompt embedding space 108. Various embedding methods known in the art may be used to compute the multidimensional embedding. It is beneficial to use the same method to compute the embedding at this stage as in the eventual embedding of the received generational prompt 114 (e.g., by LLM 116 to generate multidimensional prompt embedding 110). The multidimensional embeddings are recorded separately for each of experts 120a-120n, resulting in a unique embedding space for each of experts 120a-120n corresponding to text descriptions of only images on which the particular expert was trained (e.g., using a greedy selection algorithm). The selection algorithm may be greedy in the sense that individual training images may be included in the training sets for multiple experts (i.e., an image may depict a person who is both blonde and smiling and which may therefore be included in both the blonde and smiling experts), but the embeddings for each image are only computed once for the entire unified training set for an expert and then greedily selected as being a member of each expert on a local basis for that expert without respect to or consideration of their inclusion in the training sets of other experts. In an example, reverse prompt embedding space 108 comprises an embedding space for expert 120a (e.g., a blonde hair expert), another embedding space for expert 120b (e.g., a smiling expert), and so on – each expert trained on a given style, mood, or characteristic and having its own embedding space. Geometric properties (e.g., centroid, surface, etc.) of the embedding spaces also may be computed by style alignment module 112.

When prompt 114 is received, a multidimensional embedding for that prompt also may be computed by LLM 116 (e.g., using the same or a similar method as used for reverse prompts 105a-105n) to generate a prompt embedding 110, which also may be organized in reverse prompt embedding space 108 or provided directly to style alignment module 112. Style alignment module 112 may determine a similarity of prompt embedding 110 with a geometric property of the embedding spaces of each expert in prompt embedding space 108, so that a subset of experts in mood / style ensemble 120 may be selected for use in generating top style outputs 123. In an example, a similarity between prompt embedding 110 and an embedding space for an expert may be determined by calculating a distance between the prompt embedding 110 and the centroid of the embedding space for the expert. In another example, the distance between the prompt embedding 110 and a closest point on each expert embedding space’s surface may be used to determine similarity. In still other examples, other multidimensional similarity may be calculated. Prompt 114 may be sent through tokenizer 117 and/or additional tokenizers 118 (e.g., T5, CLIP, LLaMA, BERT, Gemma, etc.) to generation model 119 and mood / style ensemble 120 for inference only by a subset of experts 120a-120n (e.g., experts trained on images most similar to the image described by the prompt, experts included in the subset for other purposes, as described herein), thereby generating an output image (e.g., top style outputs 123, random style outputs 124). In some examples, mood / style ensemble 120 may comprise experts 120a-120n that are lightweight experts built upon a robust generation model 119. Generation model 119 may comprise any general multidimensional foundation model configured to generate images based on a text prompt (e.g., Stable Diffusion, Flux).

In some examples, the number of experts to include in the subset of experts used for each inference may be configurable (i.e., previously determined). In some examples, the subset of experts included for inference also may be configured to include any number of random experts (e.g., for increase in variety and surprise of outputs). For example, a least similar or mid-range expert may be included for various purposes (e.g., validation, variety, surprise, level setting, re-calibration, other desired feedback, etc.). In an example, given a received prompt 114 of “X-human smiling,” the received prompt will be routed only to a predetermined number (i.e., subset) of experts trained on images where X-human is smiling (e.g., subset of mood / style ensemble 120 with embedding spaces most similar to said received prompt) for inference. In another example, given a received prompt 114 of “Y-human in profile,” the received prompt will be routed only to a predetermined number (i.e., subset) of experts trained on images where Y-human is in profile (e.g., subset of mood / style ensemble 120 with embedding spaces most similar to said received prompt). Thereby prompt compliance is increased (i.e., the system will generate images using only experts competent in the prompted intent) without inference time increasing because the same number of experts will be queried regardless of how many experts are present in the MoE. In still other examples, the subset of experts may be configured to include one, or a combination, of a least similar, randomly similar, and other range of similarity for other purposes. In yet other examples, selection of the subset of experts may be varied periodically for validation, surprise, or other purposes. For example, the subset of experts may be selected to be most similar to the prompt for nine out of ten inferences (e.g., 90% of the inferences) and to be a surprise one out of every ten inferences (10% of the inferences), or in a different proportion.

In some examples, a user (e.g., someone providing prompt 114) may provide feedback (i.e., complex RLHF 122) on top style outputs 123 and random style outputs 124 to improve future human figure generations. Such complex feedback can be provided in many different forms, indicating more than just a binary assessment of the output (e.g., good vs. bad, thumbs up vs. thumbs down, and other binary feedback indications), the complex RLHF including complex feedback (e.g., reflecting accuracy, style preference, desirable characteristics, etc.). Such complex RLHF 122 may be provided back to style alignment module 112, and optionally also to mood / style ensemble 120, to influence the subset of experts selected for inference for the same or similar future prompts.

FIG. 1B is a simplified block diagram illustrating an alternative exemplary system for high likeness high compliance human figure generation, in accordance with one or more embodiments. In diagram 150, the system may comprise pre-inference components, including training data ensemble 151 (i.e., comprising raw images 151a, 151b, 151c, … 151n), image augmentation pipeline 152 (e.g., to generate augmented image data 153a, 153b, 153c, … 153n), prompt inversion 155, captioning 156, prompt CLIP 157a, image CLIP 157b, LLM / prompt embedding 158, image embedding 159, style alignment module 160, as well as inference time components, including tokenizers 164a-164b, generation model 166, mood / style ensemble 170 and complex RLHF 172.

Like-named components of diagram 150 in FIG. 1B may function the same or similarly to corresponding components in diagram 100 in FIG. 1A. For example, training data ensemble 151 comprising raw images 151a, 151b, 151c, through to 151n, may be similarly selected and provided to an image augmentation pipeline 152 as with training data ensemble 101 and image augmentation pipeline 102. Training images from training data ensemble 151 also may be used similarly as a basis for an expert (e.g., one of experts 170a-170n in mood / style ensemble 170). Each of experts 170a-170n may correspond to a mood, style, or other characteristic, similarly to experts 120a-120n. Image augmentation pipeline 152 also be configured to perform any type of desired data augmentation (e.g., desaturation, application of noise, rotation, translation, etc.), similar to image augmentation pipeline 102. In a pre-inference stage, an embedding representing each of raw images 151a-151n may be obtained through applying one, or a combination, of the following methods on each of the augmented image data 153a-153n:
(a) prompt inversion 155 resulting in a text description of the image that may be embedded using an LLM and stored in a prompt embedding space (e.g., by LLM / prompt embedding 158),
(b) captioning 156 resulting in a text description of the image that may be embedded using an LLM and stored in a prompt embedding space (e.g., by LLM / prompt embedding 158),
(c) obtaining a multimodal representation of a prompt resulting from prompt inversion 155 by prompt CLIP 157a and storing that representation in a prompt embedding space, and
(d) obtaining a multimodal representation of an image by image CLIP 157b and storing that representation in an image embedding space (e.g., image embedding 159), and
(e) two or more of the above embedding methods may be applied to an image and performed linearly, non-linearly, and by any other combination process (e.g., weighting through a learning procedure, other weighting methods).

Again, the embeddings are recorded separately for the images being trained for each expert, resulting in a unique embedding space (not shown) for each of experts 170a-170n corresponding to only the images on which the particular expert was trained (e.g., using a greedy selection algorithm). For example, a unique embedding space for expert 170amay comprise multidimensional embeddings by LLM / prompt embedding 158 and/or image embedding 159 on a subset of raw images 151a-151b that correspond to the mood, style, or characteristic of expert 170a, similarly for a unique embedding space for expert 170b, and so on. Geometric properties (e.g., centroid, surface, etc.) of the embedding spaces also may be computed such that a similarity may be determined by style alignment 160 between a received prompt 162 and each of the embedding spaces for experts 170a-170n.

In an inference stage (i.e., at inference time), a multidimensional embedding of received prompt 162 may be computed by one or more of tokenizers 164a-164b (e.g., T5, CLIP, LLaMA, BERT, Gemma, etc.). Received prompt 162 may be presented (e.g., by tokenizers 164a-164b) for inference to a subset of mood / style ensemble 170 (e.g., lightweight experts 170a-170n built upon a foundational generation model 166) that meet the predetermined criteria (e.g., thresholds) for inclusion in the subset of experts. Thereby, prompt compliance may be increased (e.g., generating images using only experts competent in the prompted intent) without increase in inference time since the same number of experts will be queried regardless of how many experts exist in the MoE (e.g., mood / style ensemble 170).

As with mood / style ensemble 120, the number of experts to include in the subset of experts may be configurable to include one, or a combination, of: a given number of experts most similar to received prompt 162, any number of experts within a given similarity score / value threshold of received prompt 162, any number of experts within another range of similarity score / value in relation to received prompt 162, an expert with the least similar score / value in relation to received prompt 162, and any other predetermined criteria. In some examples, an output generated by a subset of experts that are the most similar to, or within a given similarity score / value threshold of, received prompt 162 may comprise top style outputs 173. In some examples, an output generated by a subset of experts that includes a least similar score / value or other non-similar score / value in relation to received prompt 162 may comprise random style outputs 174. In some examples, a user (e.g., someone providing received prompt 162) may provide feedback (i.e., complex RLHF 172) on top style outputs 173 and random style outputs 174 to improve future human figure generations. Such complex feedback can be provided in many different forms, indicating more than just whether an output is good or bad, the complex RLHF including more complex feedback (e.g., accuracy, style preference, desirable characteristics, etc.). Such complex RLHF 172 may be provided back to style alignment module 160, and optionally to mood / style ensemble 170, to influence the subset of experts selected for inference for the same or similar prompts (e.g, by adjusting the probability that each expert will be sampled).

As with FIG. 1A, the number of raw images 151a-15n, augmented image data 153a-153n, embedding spaces, and experts 170a-170n may be unlimited (e.g., (O)thousands, (O)millions, (O)billions, (O)trillions, etc.) without any noticeable or significant impact to inference time.

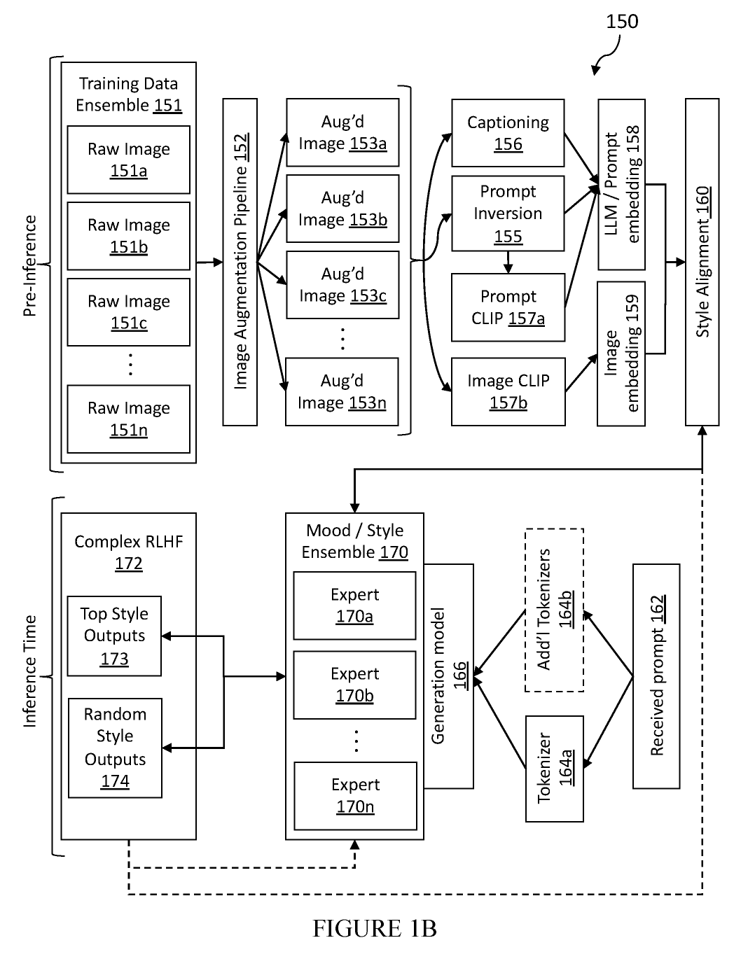

Semantic segmentation and other functions also may be applied to high likeness human figure images generated by methods described herein for scalable re-fitting of the human figure image in desired clothing (e.g., high fashion, various versions of clothing in a specified style or color), thereby achieving clothing scalability by constraining subsequent diffusion guided inpainting to maintain fit, shape, and posture characteristics while generating the same likeness in different clothing (e.g., “re-dressing”). FIG. 2 is a simplified block diagram illustrating an exemplary system for scalable fashion in high likeness AI-generated human figures, in accordance with one or more embodiments. Diagram 200 includes an AI-generated human figure 202 (e.g., output image from system 100 in FIG. 1A or system 150 in FIG. 1B, and other AI-generated human figures), semantic segmentation model 204, a clothing prompt 205, post-processing module 206, an optional reference figure 207, diffusion model 208, and a human-in-fashion figure output 210. In some examples, AI-generated human figure 202 may be generated using the systems 100 or 150 described above. In other examples, AI-generated human figure 202 may be generated by other human figure generation models (e.g., low-rank adaptation (LoRA) to a Flux model). Even though AI-generated human figure 202 may already include clothing (e.g., X-human wearing a white suit, Y-human wearing a green track suit, Z-human wearing a red dress, etc.), since human figure generation models, even those trained for high likeness and high compliance, generally are not also trained to produce well-fitting, stylish, or otherwise well-controlled clothing, it is likely AI-generated human figure 202 has ill-fitting clothes. The high likeness high compliance methods described herein may be configured to produce realistic human figure bodies in realistic postures accurate to a subject, but often are not trained to also produce well-fitted, well-controlled clothing.

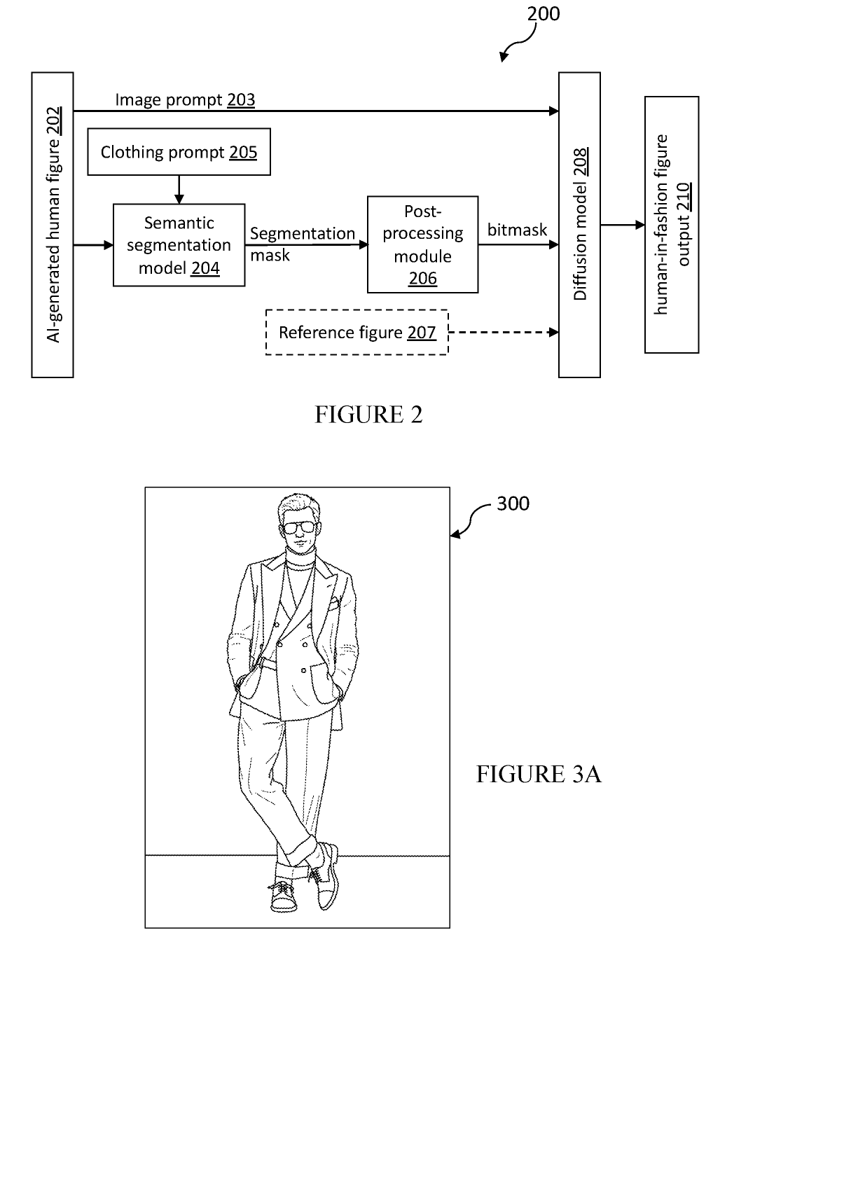

Thus, semantic segmentation may be applied to human figure 202 (i.e., an image) by semantic segmentation model 204. For example, human figure 202 may be segmented for one or more classes (e.g., suit, jacket, pants, belt, skirt, blouse, t-shirt, collared shirt, button down shirt (with or without pocket, with or without collar), cashmere sweater, half-zip sweater, and any other class of clothing). Semantic segmentation model 204 may be configured to segment using any segmentation model (e.g., SegFormer) to generate a segmentation mask. In some examples, the segmentation mask may indicate (e.g., probabilistically) which pixels likely correspond to clothing. In some examples, spatial smoothing and/or other processing (e.g., logistic regression, classification) also may be applied to the segmentation mask by a post-processing module 206, thereby generating a bitmask. A bitmask with removed pixels corresponding to a piece of clothing removed from the image of human figure 202 may be provided by post-processing module 206 to diffusion model 208, the removed pixels corresponding to pixels labeled by segmentation model 204 as likely to correspond to clothing. Diffusion model 208 may be configured to apply diffusion-guided inpainting in a zero-shot manner to fill in missing pixels with desired clothing as described in clothing prompt 205 and optionally shown in a reference figure 207 (i.e., a reference image). FIG. 3A is a line drawing illustrating an exemplary reference image providing a clothing reference for scalable fashion in high likeness human figure generation, in accordance with one or more embodiments. Reference image 300 (i.e., a reference figure) may comprise a generic image of a person wearing a desired piece of clothing (e.g., specified in clothing prompt 205). In some examples, clothing prompt 205 may include a description of desired clothing (e.g., X-human wearing a white suit, Y-human wearing a green track suit, Z-human wearing a red dress, X-human wearing a pink tutu, Y-human wearing glasses and a white labcoat, Z-human wearing polo-style shirt and khaki pants, etc.). Any inpainting technique may be performed by diffusion model 208 to generate human-in-fashion figure output 210 comprising the AI-generated human figure 202 clothed in a well-fitted desired piece of clothing. No user intervention is necessary beyond the provision of the following at inference time: (a) an image prompt (e.g., corresponding to AI-generated human figure 202), (b) class for semantic segmentation (e.g., included in clothing prompt 203), and optionally (c) a reference image (e.g., reference figure 207, reference image 300, and the like) for diffusion-guided inpainting, the reference image corresponding to a desired piece of clothing. This technique may be used to scalably clothe an AI-generated human figure in a well-fitted manner in a plurality of clothing, for example, for virtual try-ons (e.g., of a particular designer, brand, etc.), as well as for ideation purposes (e.g., try on many, different versions of a type, color, and style of clothing).

FIG. 3B is a series of line drawings illustrating an exemplary AI-generated human figure being clothed by a method for scalable fashion in high likeness AI-generated human figures, in accordance with one or more embodiments. The drawing series 310 includes AI-generated human figure 312, bitmask 314, reference figure 316, and human-in-fashion figure 318. AI-generated human figure 312 may be an example of an AI-generated human figure 202 in FIG. 2. Bitmask 314 with clothing-related pixels removed (i.e., removed pixels shown with a dotted and slashed pattern) may result from semantic segmentation (e.g., by semantic segmentation model 204), and spatial smoothing or other processing (e.g., by post-processing module 206). A human-in-fashion figure 318 may then be generated using bitmask 314 and reference figure 316 (e.g., by a diffusion-guided inpainting method).

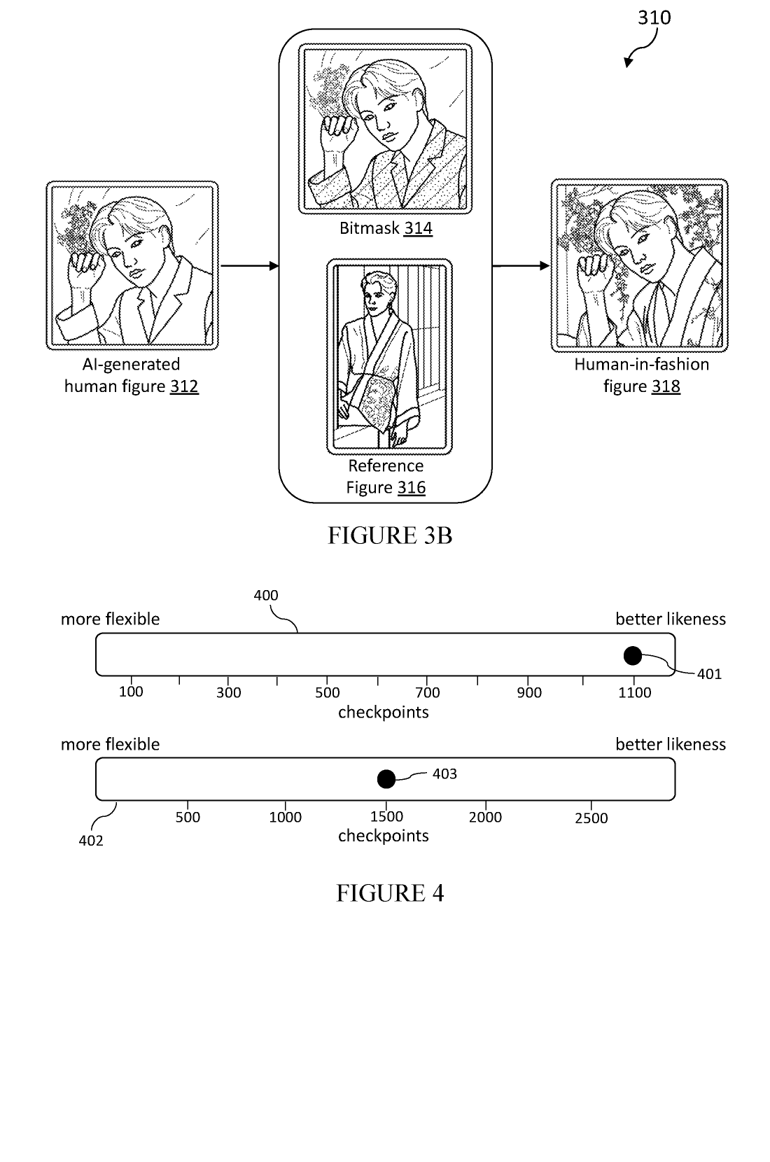

FIG. 4 is a simplified line drawing illustrating an exemplary user interface for tuning an expert to a desired training checkpoint, in accordance with one or more embodiments. As an expert learning model becomes more specialized, it becomes less flexible. Thus, in examples described herein, as an expert is being trained to have a better (i.e., higher) likeness to a given human figure and/or to a mood, style, or characteristic, the expert becomes less able to generate varied human figures. However, expert models described herein are very lightweight (e.g., trained on only a very or relatively small number of foundational model parameters relevant to the subject matter), and thus may be stored and implemented at a plurality of training checkpoints (i.e., points along a timeline of the expert’s training progress). In some examples, checkpoints may occur very often, periodically, ad hoc, or at other cadences (e.g., UI 400. User interfaces (UIs) 400 and 402 may be configured to enable a user to select a version of the expert at any of the plurality of checkpoints for inference (i.e., to generate an output), thereby allowing a user to tune an expert to a level of expertise comprising a desired level of flexibility vs. high likeness. In some examples, UIs 400 and 402 each may comprise a bar representing a timeline of checkpoints from a more flexible (i.e., less trained, less specialized) checkpoint to a better likeness (i.e., more trained, more specialized) checkpoint. In some examples, UI 400 may comprise an icon 401 and UI 402 may comprise an icon 403, icons 401 and 403 able to be moved by a user (e.g., using an input device, as described herein) along a spectrum (i.e., the timeline) from a more flexible checkpoint to a better likeness checkpoint, the selected checkpoint indicating a level of trained expertise of the expert being used to generate a human figure output (e.g., top style outputs 123 and b, random style outputs 124 and 174, AI-generated human figure 202, and the like) and corresponding to a stored version of the expert. In other examples, other selection mechanisms may be provided to allow a user to select a version of a trained expert that corresponds to a desired checkpoint along a training timeline, for example, a slider along a vertical bar, a button selection mechanism, a drop down menu, etc.

In some examples, UI 400 and UI 402 each may correspond to a given expert (e.g., one for blonde hair, one for smiling expression, one for face in profile, one for white suit, one for polka dot dress, etc.). In other examples, each of UI 400 and UI 402 may represent a subset of experts for a type of attribute (e.g., one for a subset of experts trained on hair color, one for a subset of experts trained on facial expressions, one for a subset of experts trained on a type of clothing, one for a subset of experts trained on hairstyles). In still other examples, each of UI 400 and UI 402 may represent all of the experts trained for a given human figure, such that any image generated of that human FIGURE(e.g., with any hair, any facial expression, any style of clothing, any background, etc.) is tuned to the same level of expertise.

While the techniques (i.e., methods and systems) described herein use human figure generation as examples, these techniques also may be applicable to generation of other images (e.g., animals, plants, vehicles, etc.).

### Example Methods

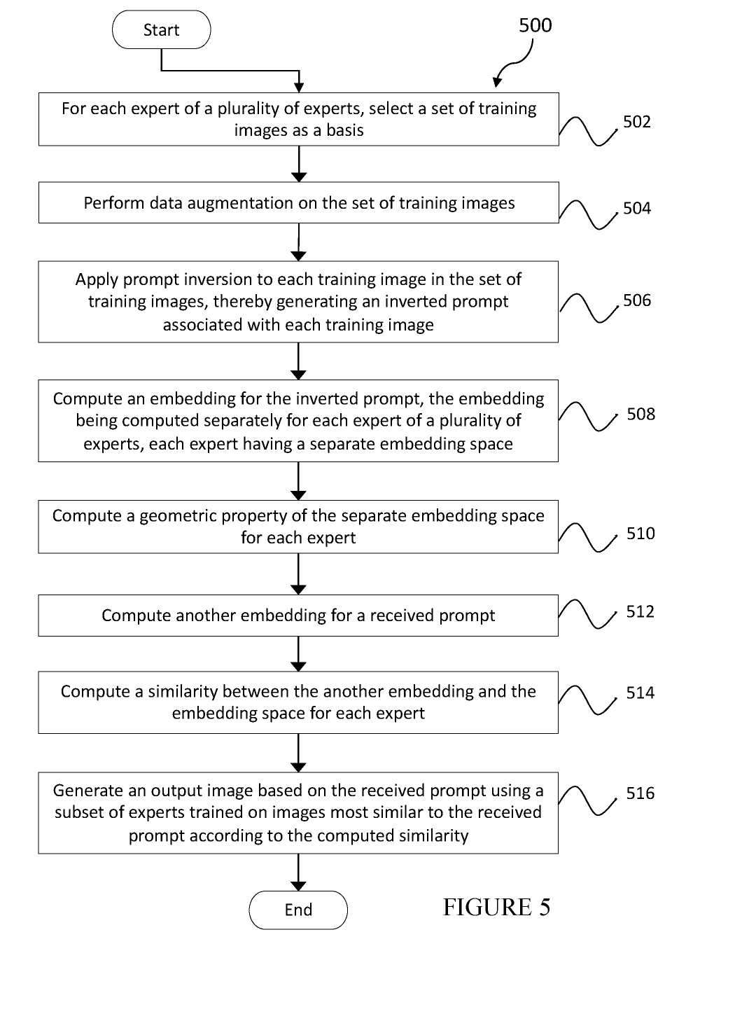

FIG. 5 is a flow diagram illustrating a method for generating a high likeness high compliance human figure, in accordance with one or more embodiments. In method 500, a set of training images may be selected as a basis for each expert of a plurality of experts in step 502. Data augmentation may be performed (e.g., by an image augmentation pipeline) on the set of training images at step 504. Such data augmentation may comprise one, or a combination, of desaturation, application of noise, rotation, translation, and other data augmentation techniques. Prompt inversion may be applied to each training image in the set of training images at step 506, thereby generating an inverted prompt associated with each training image. An embedding for the inverted prompt may be computed at step 508, the embedding being recorded separately within each expert of a plurality of experts, resulting in each expert having a separate (i.e., unique) embedding space. The embedding may comprise a multidimensional embedding. In some examples, each expert comprises a lightweight learning model built on a foundational model and trained for expertise in a given mood, style, other characteristic, the plurality of experts comprising a mood / style ensemble (i.e., an MoE). A geometric property of the separate embedding space for each expert may be computed at step 510. In some examples, the geometric property may comprise one, or a combination, of a centroid, a surface, and another geometric property. A prompt may be received for inference, and another embedding computed for the received prompt, at step 512. A similarity between the another embedding (i.e., prompt embedding) and the embedding space for each expert may be computed at step 514. In some examples, the similarity may be determined by calculating a distance between the another embedding and the centroid of the embedding space for each expert. In other examples, the similarity may be determined by calculating a distance from the another embedding to a closest point on the surface of the embedding space for each expert. An output image based on the received prompt may be generated using a subset of experts trained on images most similar to the received prompt according to the computed similarity at step 516.

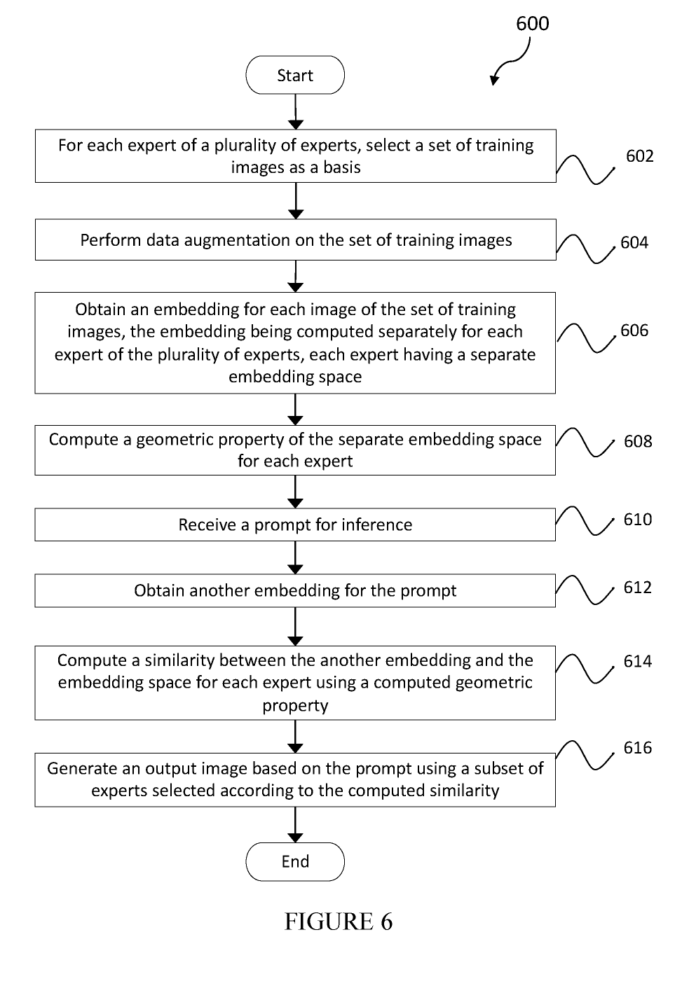

FIG. 6 is a flow diagram illustrating an alternative method for generating a high likeness high compliance human figure, in accordance with one or more embodiments. In method 600, a set of training images may be selected as a basis for each expert of a plurality of experts in step 602. Data augmentation may be performed (e.g., by an image augmentation pipeline) on the set of training images at step 604. Such data augmentation may comprise one, or a combination, of desaturation, application of noise, rotation, translation, and other data augmentation techniques. An embedding for each image of the set of training images may be obtained at step 606, the embedding being recorded separately for each expert of a plurality of experts, resulting in each expert having a separate (i.e., unique) embedding space. The embedding may comprise a multidimensional embedding. In some examples, each expert comprises a lightweight learning model built on a foundational model and trained for expertise in a given mood, style, other characteristic, the plurality of experts comprising a mood / style ensemble (i.e., an MoE). A geometric property of the separate embedding space for each expert may be computed at step 608. In some examples, the geometric property may comprise one, or a combination, of a centroid, a surface, and another geometric property. A prompt may be received for inference at step 610, and another embedding computed for the prompt at step 612. In some examples, the another embedding (i.e., prompt embedding) is computed using the same embedding technique as used in embedding the set of training images (e.g., when multimodal embeddings such as CLIP are used). A similarity between the another embedding and the embedding space for each expert may be computed at step 614, using a computed geometric property (e.g., the geometric property computed for the separate embedding space for each expert). In some examples, the similarity may be determined by calculating a distance between the another embedding and the centroid of the embedding space for each expert. In other examples, the similarity may be determined by calculating a distance from the another embedding to a closest point on the surface of the embedding space for each expert. An output image based on the prompt may be generated at step 616 using a subset of experts selected according to the computed similarity.

In some examples, a multidimensional embedding may be obtained in the methods described herein by one, or a combination, of the following methods:

(a) using an LLM to embed a text description (e.g., a prompt, a reverse prompt obtained through prompt inversion, captioning, etc.),

(b) obtaining a multimodal representation of a text description (e.g., a prompt, a reverse prompt obtained through prompt inversion, captioning, etc.) using CLIP,

(d) obtaining a multimodal representation of an image using CLIP, and

(e) two or more of the above embedding methods performed linearly, non-linearly, and by any other combination process (e.g., weighting through a learning procedure, other weighting methods).

In some examples, the subset of experts used in the methods described herein may comprise a given number of experts that are most similar to a received prompt. In some examples, the computed similarity may be determined by calculating a distance between the another embedding and the centroid of the embedding space for each expert. In another example, a distance from the another embedding to a closest point on each expert embedding space’s surface may be used to determine similarity. In still other examples, another multidimensional similarity may be calculated. In alternative examples, the subset of experts may include experts that are less similar (e.g., less compliant, more different) from a prompt (e.g., where the computed similarity is lower) for validation, variety, surprise, or other purposes. As described herein the subset of experts included for inference may be configurable for different purposes. As described herein, there are no limits to the number of images in the set of training images and to the number of experts in the mood / style ensemble.

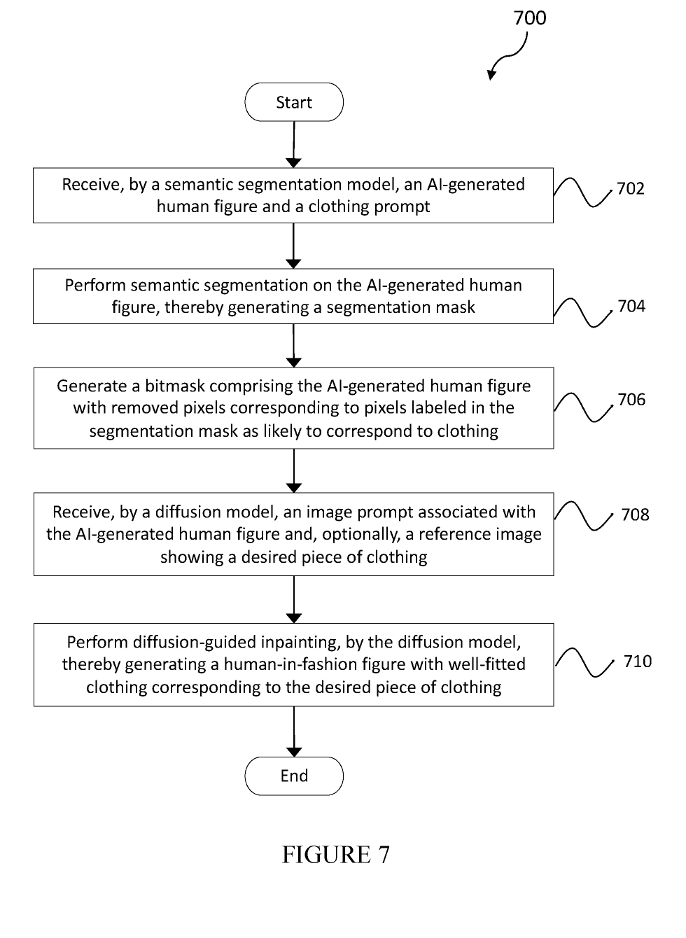

FIG. 7 is a flow diagram illustrating a method for scalable fashion in high likeness AI-generated human figures, in accordance with one or more embodiments. Method 700 may begin with receiving, by a semantic segmentation model, an AI-generated human figure and a clothing prompt at step 702. Semantic segmentation on the AI-generated human figure may be performed at step 704, thereby generating a segmentation mask. A bitmask comprising the AI-generated human figure with removed pixels may be generated at step 706, the removed pixels corresponding to pixels labeled in the segmentation mask as likely to correspond to clothing. In some examples, the bitmask may be generated by one, or a combination, of spatial smoothing, logistic regression, classification, and other processing techniques. An image prompt associated with the AI-generated human figure may be received by a diffusion model at step 708. Optionally, a reference image showing a desired piece of clothing may also be received by the diffusion model. Diffusion-guided inpainting may be performed by the diffusion model at step 710, thereby generating a human-in-fashion figure with well-fitted clothing corresponding to the desired piece of clothing.

Method 700 may be used to scalably clothe an AI-generated human figure in a well-fitted manner in a plurality of clothing, for example, for virtual try-ons (e.g., of a particular designer, brand, etc.), as well as for ideation purposes (e.g., try on many, different versions of a type, color, and style of clothing).

### Example Computing Systems

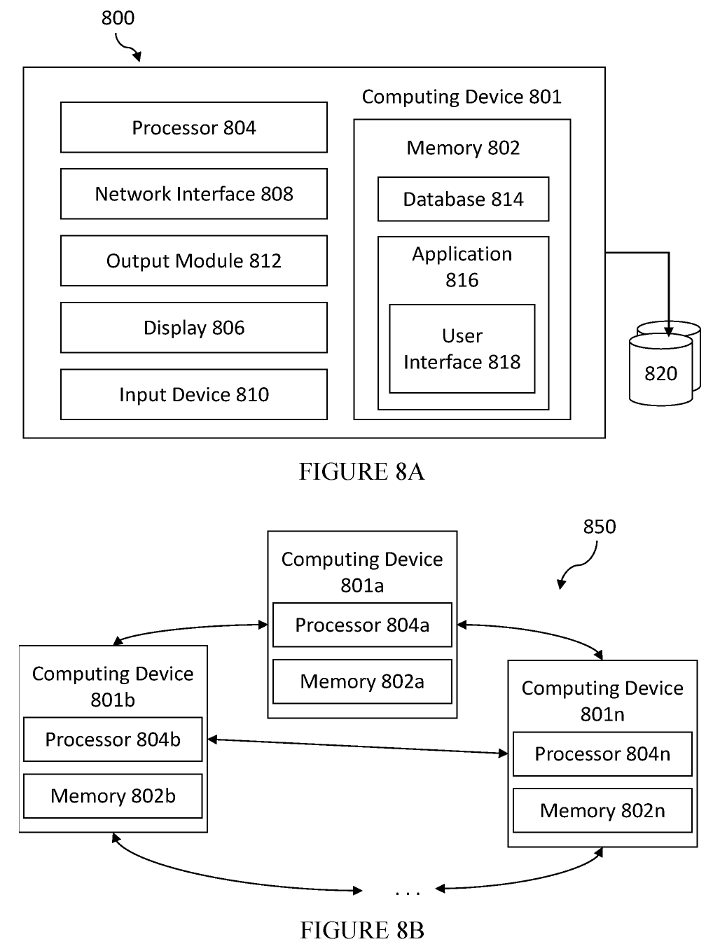

FIG. 8A is a simplified block diagram of an exemplary computing system configured to implement the systems shown in FIGS. 1A-1B and 2, interfaces shown in FIG. 4, and to perform steps of the method illustrated in FIGS. 5-7, in accordance with one or more embodiments. In one embodiment, computing system 800 may include computing device 801 and storage system 820. Storage system 820 may comprise a plurality of repositories and/or other forms of data storage, and it also may be in communication with computing device 801. In another embodiment, storage system 820, which may comprise a plurality of repositories, may be housed in one or more of computing device 801. In some examples, storage system 820 may store data and datasets (e.g., training data ensemble, augmented image data, prompts, reverse prompts, embedding spaces, mood / style ensemble, generated image outputs, other metadata and metrics, etc.), hyperparameters and other parameters, preferences, instructions, programs, AI models, other neural networks, other models, and various types of other information as described herein. This information may be retrieved or otherwise accessed by one or more computing devices, such as computing device 801, in order to perform some or all of the features described herein. Storage system 820 may comprise any type of computer storage, such as a hard-drive, memory card, ROM, RAM, DVD, CD-ROM, write-capable, and read-only memories. In addition, storage system 820 may include a distributed storage system where data is stored on a plurality of different storage devices, which may be physically located at the same or different geographic locations (e.g., in a distributed computing system such as system 850 in FIG. 8B). Storage system 820 may be networked to computing device 801 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 801 also may include a memory 802. Memory 802 may comprise a storage system configured to store a database 814 and an application 816. Application 816 may include instructions which, when executed by a processor 804, cause computing device 801 to perform various steps and/or functions, as described herein. Application 816 further includes instructions for generating a user interface 818 (e.g., graphical user interface (GUI) and other UIs, as described herein). Database 814 may store various algorithms and/or data, including neural networks, foundational models, other AI models, other learning models, data associated with image processing, image and prompt embedding, neural networks, style alignment (e.g., similarity between embedding spaces and prompt embeddings), hyperparameters, user preferences, among other types of data. Memory 802 may include any non-transitory computer-readable storage medium for storing data and/or software that is executable by processor 804, and/or any other medium which may be used to store information that may be accessed by processor 804 to control the operation of computing device 801.

Computing device 801 may further include a display 806, a network interface 808, an input device 810, and/or an output module 812. Display 806 may be any display device by means of which computing device 801 may output and/or display data. Network interface 808 may be configured to connect to a network using any of the wired and wireless short range communication protocols described above, as well as a cellular data network, a satellite network, free space optical network and/or the Internet. Input device 810 may be a mouse, keyboard, touch screen, voice interface, and/or any or other hand-held controller or device or interface by means of which a user may interact with computing device 801. Output module 812 may be a bus, port, and/or other interface by means of which computing device 801 may connect to and/or output data to other devices and/or peripherals.

In one embodiment, computing device 801 is a data center or other control facility (e.g., configured to run a distributed computing system as described herein), and may communicate with a client device. As described herein, system 800, and particularly computing device 801, may be used for image augmentation, prompt and image embedding, geometric property computations, generating metadata, natural language processing, implementing LLMs and other AI models, inference by foundational models and expert models, and otherwise implementing steps in generating a high likeness high compliance human figure and clothing said human figure in well-fitted fashion, as described herein. Various configurations of system 800 are envisioned, and various steps and/or functions of the processes described herein may be shared among the various devices of system 800 or may be assigned to specific devices.

FIG. 8B is a simplified block diagram of an exemplary distributed computing system implemented by a plurality of the computing devices, in accordance with one or more embodiments. System 850 may comprise two or more computing devices 801a-n. In some examples, each of 801a-n may comprise one or more of processors 804a-n, respectively, and one or more of memory 802a-n, respectively. Processors 804a-n may function similarly to processor 804 in FIG. 8A, as described above. Memory 802a-n may function similarly to memory 802 in FIG. 8A, as described above. One or more computing devices 801a-n may implement a server-side processer, as described herein. One or more other of computing devices 801a-n may implement a client-side processor or component, as described herein.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for generating a high likeness high compliance human figure comprising:
selecting a set of training images as a basis for each expert of a plurality of experts;
performing data augmentation on the set of training images;
obtaining an embedding for each image of the set of training images, the embedding being recorded separately for each expert of the plurality of experts, each expert having a separate embedding space;
computing a geometric property of the separate embedding space for each expert;
receiving a prompt for inference;
obtaining another embedding for the prompt;
computing a similarity between the another embedding and the embedding space for each expert using the geometric property; and
generating an output image based on the prompt using an inference by a subset of experts selected according to the computed similarity, the output image comprising a high likeness high compliance human figure.

2. The method of claim 1, wherein each expert of the plurality of experts is trained in one mood, style, or other characteristic.

3. The method of claim 1, wherein each expert comprises a low-rank adaptation (LoRA) of a foundation model.

4. The method of claim 1, wherein data augmentation comprises one, or a combination, of desaturation, application of noise, rotation, and translation.

5. The method of claim 1, wherein obtaining the embedding and obtaining the another embedding comprises use of a same embedding technique.

6. The method of claim 1, wherein the embedding comprises a multimodal representation of an image and the another embedding comprises a multimodal representation of a prompt.

7. The method of claim 1, wherein the embedding and the another embedding are obtained using one, or a combination, of an LLM, a prompt CLIP, and an image CLIP.

8. The method of claim 8 wherein the embedding and the another embedding are obtained by a weighted combination of two or more of the LLM, the prompt CLIP, and the image CLIP.

9. The method of claim 1, wherein the geometric property comprises one or both of a centroid and a surface.

10. The method of claim 9, wherein computing the similarity between the another embedding and the embedding space for each expert comprises calculating a distance between the another embedding and the centroid of the embedding space for each expert.

11. The method of claim 9, wherein computing the similarity between the another embedding and the embedding space for each expert comprises calculating a distance from the another embedding to a closest point on the surface of the embedding space for each expert.

12. The method of claim 1, further comprising selecting the subset of experts to include a given number of experts that are most similar to the prompt.

13. The method of claim 1, further comprising selecting the subset of experts to include an expert outside of a similarity threshold to the prompt.

14. The method of claim 1, further comprising returning complex reinforcement learning with human feedback (RLHF) for selecting the subset of experts for a same or similar future prompt.

15. A system for generating a high likeness high compliance human figure comprising:
a memory comprising non-transitory computer-readable storage medium configured to store image data, a plurality of embeddings, and a plurality of experts;
one or more processors configured to execute instructions stored on the non-transitory computer-readable storage medium to implement:
a training data ensemble configured to store a plurality of images;
an image augmentation pipeline configured to perform data augmentation on the plurality of images;
a neural network configured to generate an embedding for each of the plurality of images;
a mood and style ensemble of a plurality of experts, each expert comprising a lightweight model being built on a foundational model;
a separate embedding space for each expert in the plurality of experts; and
a tokenizer configured to generate a prompt embedding.

16. The system of claim 15, wherein the neural network comprises a large language model (LLM).

17. The system of claim 15, wherein the neural network is configured to generate a multimodal representation of an image.

18. The system of claim 15, wherein the neural network comprises a Contrastive Language-Image Pre-training (CLIP) model.

19. The system of claim 15, wherein the one or more processors is configured to also implement a complex reinforcement learning with human feedback loop.

20. The system of claim 15, wherein each expert comprises a low-rank adaptation (LoRA) of the foundation model.
